(19) United States
(12) Patent Application Publication
(10) Pub. No.: US 2021/0186784 A1
(43) Pub. Date: Jun. 24, 2021

(54) SUPPORT SURFACE OVERLAY WITH VACUUM ENCLOSURE AND METHOD OF OPERATION

(71) Applicant: DABIR SURFACES, INC., Chicago, IL (US)

(72) Inventor: David A. DZIOBA, Frankenmuth, MI (US)

(21) Appl. No.: 17/125,920

(22) Filed: Dec. 17, 2020

Related U.S. Application Data
(60) Provisional application No. 62/949,961, filed on Dec. 18, 2019.

(51) Int. Cl. A61G 7/057

(52) U.S. Cl. CPC A61G 7/05776; A61G 2203/34; A61G 7/05792

(57) ABSTRACT

A support surface overly having first and second independently inflatable compartments is disposed within an envelope. Air may be removed from the envelope so that side panels of the envelope collapse against corresponding surfaces of the overlay to inhibit lateral motion of the panels with respect to the surfaces of the overlay.

### CROSS-REFERENCE TO RELATED APPLICATIONS

This application claims benefit under 35 U.S.C. § 120 of U.S. Provisional Patent Application No. 62/949,961, filed on Dec. 18, 2019, the disclosure of which is incorporated by reference herein in its entirety.

### BACKGROUND AND SUMMARY OF THE DISCLOSURE

Alternating pressure support surface overlays are known in the art. Some such overlays include a bladder having first and second selectively and independently inflatable and deflatable compartments. The first compartment may be inflated while the second compartment is deflated and vice versa so that the bladder selectively applies and relieves pressure to different parts of the body of a patient or other user disposed thereon.

It also is known in the art to enclose such a bladder within an envelope, the envelope including a lower panel below the overlay bladder and an upper panel above the bladder. In some instances, the upper and lower panels of the envelope are imperforate. In others, at least one of the upper and lower panels (usually the upper panel) is perforated to allow pressurized air to flow from within the envelope to outside the envelope, thereby providing ventilating air to the body of a user thereon.

A drawback to such an arrangement is that the bladder may be loosely enclosed within the envelope so that at least one panel of the envelope is prone to shifting laterally with respect to the overlay when the assembly is manipulated, particularly with a patient or other user disposed thereon. This can lead to bunching or wrinkling of the panel(s) of the envelope, thereby creating pressure points adversely affecting patient comfort and the efficacy of the overlay. Alternatively or additionally, the bladder may shift or bunch up within the envelope, also thereby creating pressure points adversely affecting patient comfort and the efficacy of the overlay.

It would be desirable to control such shifting of the panel(s) of the envelope and shifting of the bladder therein. The disclosure shows and describes illustrative embodiments of a system configured and operable to do so.

### BRIEF DESCRIPTION OF THE DRAWINGS

FIG. 1 is a top is a top plan view of an illustrative system according to the present disclosure, the system including a bladder having first and second selectively and independently inflatable compartments disposed within an interior region of an envelope, the envelope including a first panel, a second panel, and a seam joining the first panel and the second panel to the overlay;

FIG. 2 is a bottom plan view of the system of FIG. 1;

FIG. 3 is a cross-sectional view of the system of FIG. 1;

FIG. 4 is a detail view of a portion of the bladder of FIG. 1;

FIG. 5 is a side elevation view of the system of FIG. 1;

FIG. 6 is a partial top plan view of the system of FIG. 1 according to the present disclosure, showing some of the features thereof in greater detail;

FIG. 7 is a schematic diagram of an illustrative pneumatic system configured to selectively pressurize the first and second inflatable compartments and to selectively draw air from the interior region of the envelope;

FIG. 8 is a cross-sectional end elevation view of the system of FIG. 1 showing the layers of the envelope in relation to the bladder with both of the inflatable compartments of the bladder shown schematically in a deflated condition, and the envelope at atmospheric pressure;

FIG. 9 is a cross-sectional end elevation view of the system of FIG. 1 with one of the inflatable compartments of the bladder in an inflated condition, the other of the inflatable compartments of the bladder in a deflated condition, and the envelope at atmospheric pressure;

FIG. 10 is a perspective and a cross-sectional end elevation view of the system of FIG. 1 with both of the inflatable compartments of the bladder in an inflated condition, and the envelope at atmospheric pressure;

FIG. 11 is a cross-sectional end elevation view of the system of FIG. 1 with one of the inflatable compartments of the bladder in an inflated condition, the other of the inflatable compartments of the bladder in a deflated condition, and a first proportion of air removed from the interior region of the envelope so that the first panel of the envelope conforms to the surfaces of the bladder to a greater degree than does the second panel of the envelope;

FIG. 12 is a perspective and a cross-sectional end elevation view of the system of FIG. 1 with both of the inflatable compartments of the bladder in an inflated condition, and a first proportion of air removed from the interior region of the envelope so that the first panel of the envelope conforms to the surfaces of the bladder to a greater degree than does the second panel of the envelope;

FIG. 13 is a cross-sectional end elevation view of the system of FIG. 1 with one of the inflatable compartments of the bladder in an inflated condition, the other of the inflatable compartments of the bladder in a deflated condition, and a second proportion of air greater than the first proportion of air removed from the interior region of the envelope so that the first panel of the envelope conforms to the surfaces of the bladder to a similar degree as does the second panel of the envelope; and

FIG. 14 is a cross-sectional end elevation view of the system of FIG. 1 with one of the inflatable compartments of the bladder in an inflated condition, the other of the inflatable compartments of the bladder in a deflated condition, and a third proportion of air greater than the second proportion of air removed from the interior region of the envelope so that the first panel of the envelope conforms more closely to the surfaces of the bladder to a similar degree as does the second panel of the envelope.

### DETAILED DESCRIPTION OF THE DRAWINGS

The drawings show an illustrative embodiment of a system including a support surface overlay 10 having a bladder 100 and an envelope 200 containing the bladder 100. The system also includes a control system 300 configured to selectively pressurize the bladder 100 and withdraw air from the envelope 200, as will be discussed further below.

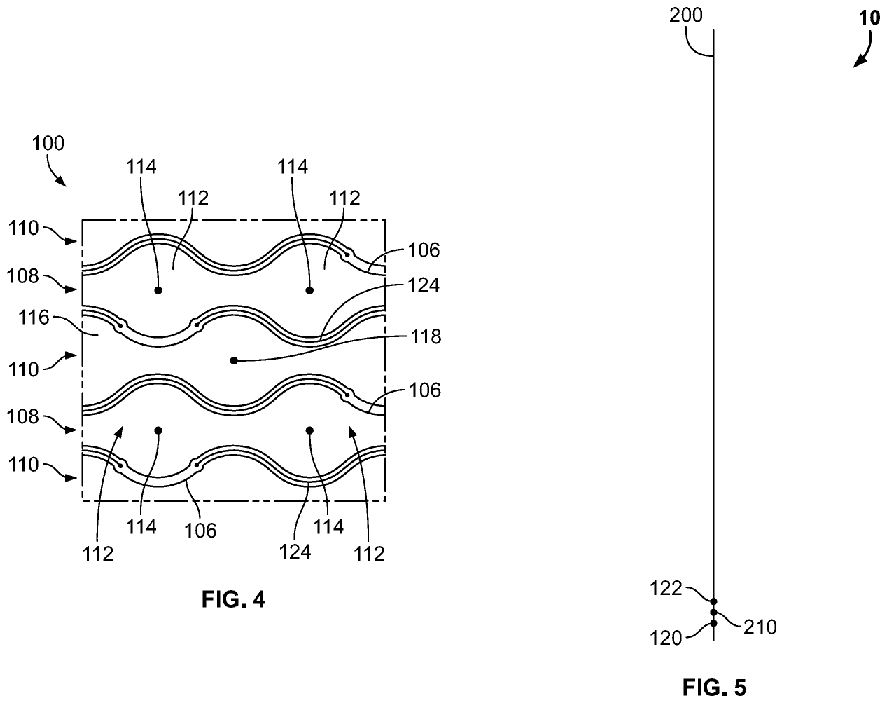

The bladder 100 includes a first (or upper) flat, flexible sheet 102 overlying a second (or lower) flat, flexible sheet 104. One or both of the first and second sheets 102, 104 may be imperforate. The first and second sheets 102, 104 are joined together by a generally sinusoidal seam 106, thereby defining first and second interdigitated inflatable compartments 108, 110. As best shown in FIG. 4, the seam 106 may define one or more relief cuts 124, for example, as further described in U.S. Pat. No. 9,216,122, the disclosure of which is incorporated by reference herein.

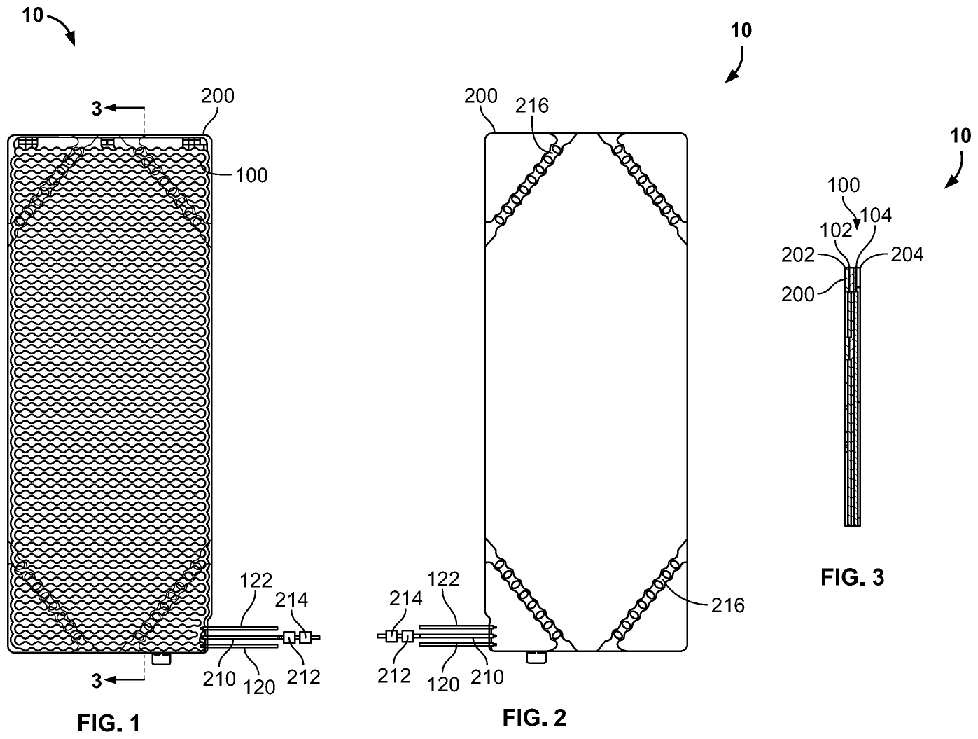

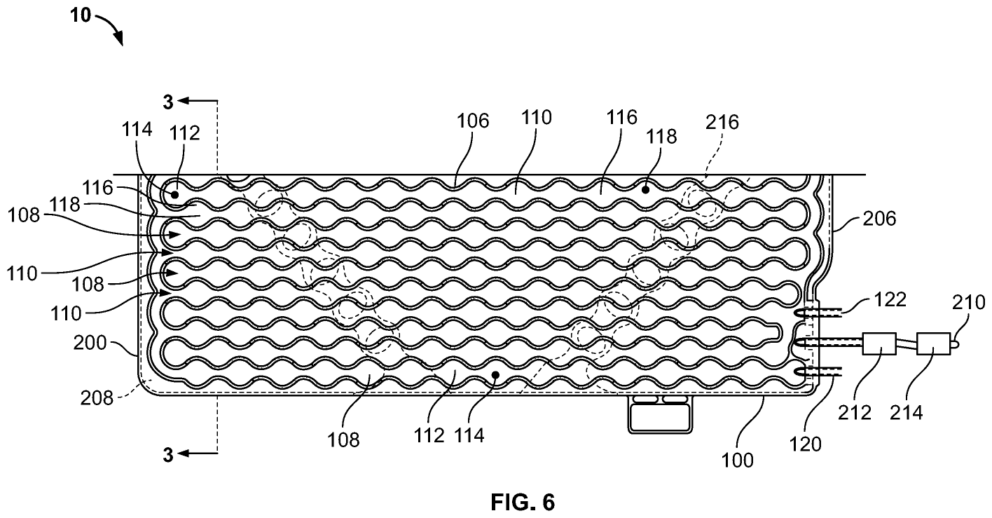

The first and second compartments 108, 110 may be selectively and independently inflated and deflated. The first compartment 108 may define a first plurality of inflatable cells 112 arranged in rows, each of the first plurality of inflatable cells 112 defining a corresponding contact node 114 when inflated. The second compartment 110 may define a second plurality of inflatable cells 116 arranged in rows interdigitated with the rows of the first plurality of inflatable cells 112, each of the second of inflatable cells 116 defining a corresponding contact node 118 when inflated. As best shown in FIGS. 1 and 6, the rows of first and second inflatable cells 112, 116 may extend in a side-to-side direction of the overlay 100. In other embodiments, the rows of first and second inflatable cells 112, 116 may extend in an end-to-end direction of the overlay 100, perpendicular to that shown. In further embodiments, the rows of first and second inflatable cells 112, 116 could extend in other directions.

In other embodiments, the bladder 100 could take any number of alternative forms.

A first bladder tube 120 defining a lumen therethrough extends from the first compartment 108 in fluid communication therewith. A second bladder tube 122 defining a lumen therethrough extends from the second compartment 110 in fluid communication therewith. The first and second bladder tubes 120, 122 are joined or otherwise connected to one or both of the first and second sheets 102, 104 in sealed engagement therewith. The free ends of the first and second bladder tubes 120, 122 are configured for connection to the control system 300, for example, via an intervening connector 308, as will be discussed further below.

The envelope 200 includes a first (or upper) flexible panel 202 overlying a second (or lower) flexible panel 204. (In FIGS. 1 and 6, the upper panel 202 is shown as being transparent for clarity.) The first and second panels 202, 204 are joined together by at least one generally circumferential seam 206, thereby defining an interior region 208 of the envelope. The first and second panels 202, 204 of the envelope 200 may be joined together directly. Alternatively, the first and second panels 202, 204 of the envelope 200 may be joined together through an intervening structure. For example, the first panel 202 of the envelope 200 may be joined to the first sheet 102 of the bladder 100 by a seam 206, and the second panel 204 of the envelope 200 may be joined to the second sheet 104 of the bladder 100 by the seam 206 or another seam.

One or both of the first and second panels 202, 204 of the envelope 200 are made of flat, flexible sheets of material. One or both of the first and second sheets are imperforate or sufficiently imperforate that a vacuum may be drawn upon the interior region 208 thereof, as will be discussed further below.

The first and second panels 202, 204 may be configured so that the first panel 202 stretches elastically to a greater degree than does the second panel 204 when the first panel 202 and the second panel 204 are subjected to the same or similar tensile load, as will be discussed further below. To this end, the first and second panels 202, 204 could be made of different materials having different material properties, or they could be made of the same material of different thicknesses, or both. In an embodiment, the first panel 202 is substantially thinner than the second panel 204, for example, half the thickness of the second panel 204, so that the first panel 202 stretches elastically to a greater degree than does the second panel 204 when the first panel 202 and the second panel 204 are subjected to the same or similar tensile load. In other embodiments, the envelope 200 could take any number of alternative forms.

An envelope tube 210 defining a lumen therethrough extends from the interior region 208 in fluid communication therewith. The envelope tube 210 is joined or otherwise connected to either or both of the first and second panels 202, 204 in sealed engagement therewith. The envelope tube 210 includes an optional in-line envelope filter 212 configured to capture biohazardous material that may be present in the interior region 208 of the envelope 200 and mitigate a likelihood of such biohazardous material from contaminating the controller 300. The envelope tube 210 also includes an in-line calibrated envelope check valve 214 outboard of the optional in-line envelope filter 212, and configured to preclude undesired entry of air from atmosphere to the interior region 208 of the envelope 200. In other embodiments, the locations of the in-line calibrated envelope check valve 214 and the optional in-line envelope filter 212 could be reversed with respect to each other. The free end of the envelope tube 210 is configured for connection to the control system 300, for example, via an intervening connector 308, as will be discussed further below.

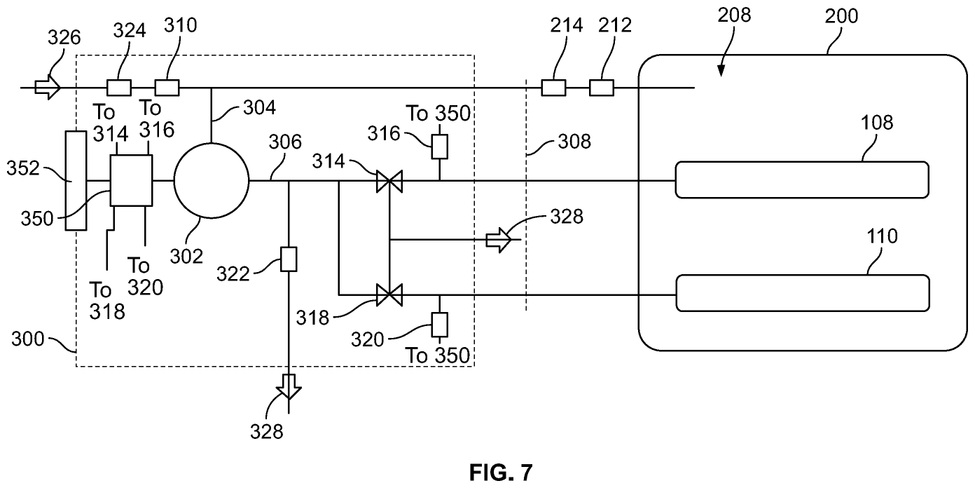

The control system 300 is operable to selectively and independently force pressurized air (or another medium) into, and relieve the air (or other medium) from, the first and second compartments 108, 110 to selectively and independently inflate and deflate the corresponding inflatable cells 112, 116 through the first and second bladder tubes 120, 122. The control system 300 also is operable to selectively withdraw air (or another medium) from the interior region 208 of the envelope 200 to selectively collapse the first and second panels 202, 204 of the envelope 200 against the first and second sheets 102, 104 of the bladder 100 within the envelope 200. As shown in FIG. 7, the control system 300 includes a pump 302, which may be a pneumatic pump. The control system 300 also includes a pneumatic circuit including a valve or manifold arrangement configured to selectively align the suction of the pump 302 in fluid communication with the interior region 208 of the envelope 200, and to selectively align the discharge of the pump 302 in fluid communication with one or both of the first and second inflatable compartments 108, 110 of the bladder 100.

More specifically, the pneumatic circuit includes a pump input (or suction) line 304 in selective fluid communication with an input (or suction) port of the pump 302. The pump suction line 304 also is in selective fluid communication with the atmosphere via a calibrated vacuum relief valve 310. The calibrated vacuum relief valve 310 is in parallel with the calibrated envelope check valve 214. A filter 324 may be provided on the side of the calibrated vacuum relief valve 310 opposite the pump 302 to filter air drawn from the atmosphere into the controller 300.

The calibrated vacuum relief valve 310 is configured to be closed when the pressure in the suction line 304 is at or above a predetermined suction line pressure (which may be referred to herein as the calibrated vacuum relief valve setpoint pressure), and to open when the pressure in the suction line 304 is below the predetermined suction line pressure.

The pneumatic circuit also includes a pump output (or pressure) line 306 in selective fluid communication with an output (or pressure) port of the pump 302. The pump pressure line 306 is in selective fluid communication with the first inflatable compartment 108 of the bladder 100 via the first bladder tube 120 and an intervening, three-way, first compartment isolation valve 314. The first compartment isolation valve 314 is power-operated, for example, solenoid-operated. Also, the first inflatable compartment 108 of the bladder 100 is in selective fluid communication with the atmosphere through an air outlet 328 via the first bladder tube 120 and the intervening first compartment isolation valve 314. With the first compartment isolation valve 314 in a first position, the first inflatable compartment 108 of the bladder 100 is in fluid communication with the pump pressure line 306 and not with the atmosphere. With the first compartment isolation valve 314 in a second position, the first inflatable compartment 108 of the bladder 100 is in fluid communication with the atmosphere and not with the pump pressure line 306. A first inflatable compartment pressure sensor 316 is configured to sense pressure in a pneumatic line connecting the first inflatable compartment 108 to the first inflatable compartment isolation valve 314.

Similarly, the pump pressure line 306 is in selective fluid communication with the second inflatable compartment 110 of the bladder 100 via the second bladder tube 122 and an intervening, three-way, second compartment isolation valve 318. The second compartment isolation valve 318 is power-operated, for example, solenoid-operated. Also, the second inflatable compartment 110 of the bladder 100 is in selective fluid communication with the atmosphere through an air outlet 328 via the second bladder tube 122 and the intervening second compartment isolation valve 318. With the second compartment isolation valve 318 in a first position, the second inflatable compartment 110 of the bladder 100 is in fluid communication with the pump pressure line 306 and not with the atmosphere. With the second compartment isolation valve 318 in a second position, the second inflatable compartment 110 of the bladder 100 is in fluid communication with the atmosphere and not with the pump pressure line 306. A second inflatable compartment pressure sensor 320 is configured to sense pressure in a pneumatic line connecting the second inflatable compartment 110 to the second inflatable compartment isolation valve 318.

As suggested above, one or more pneumatic connectors 308 may be provided to facilitate connection and disconnection of the control system 300 pneumatic lines to and from the first bladder tube 120, the second bladder tube 122, and the envelope tube 210 of the bladder 100.

The control system 300 includes a controller 350 configured to receive inputs from a user interface panel 352, to receive inputs from the first inflatable compartment pressure sensor 316, and from the second inflatable compartment pressure sensor 320. The controller 350 also is configured to provide control outputs to the pump 302, to the first compartment isolation valve 314, and to the second compartment isolation valve 318 to thereby selectively turn the pump 302 on and off and to selectively change the states of the first compartment isolation valve 314 and the second compartment isolation valve 318 valve between respective open and closed positions, as will be discussed further below.

The user interface panel 352 may include user input devices, for example without limitation, sensors, switches, touchscreens, and the like, enabling user control of the control system 350 and/or components thereof. The user input devices may be operable to enable user control of any number of system functions, for example, on/off, cycle time, cycle programs, and inflatable compartment pressures, among others. The controller 350 may selectively cause the pump 302 to turn on and off based on any or all of user input from the user input devices, input from hardware or software resident in the controller 350 or elsewhere, and input from the first inflatable compartment pressure sensor 316 and the second inflatable compartment pressure sensor 320. Also, the controller 350 may be configured to selectively effect various alignments of the first compartment isolation valve 314 and the second compartment isolation valve 318 valve between respective open and closed positions, as will be discussed further below.

As mentioned above, the control system 300 is operable to selectively provide pressurized air to the first and second compartments 108, 110 of the bladder 100 to thereby inflate and deflate the first and second compartments 108, 110. More specifically, the control system 300 is configured to selectively provide pressurized air to, and relieve pressurized air from, the first and second compartments 108, 110. The control system 300 may provide pressurized air to either or both of the first and second compartments 108, 110 at the same time or alternatingly, and to relieve pressurized air from either or both of the first and second compartments 108, 110 at the same time or alternatingly. As such, at any time, both of the first and second compartments 108, 110 may be fully or partially inflated at the same time, both of the first and second compartments 108, 110 may be fully or partially deflated at the same time, one of the first and second compartments 108, 110 may be fully or partially inflated while the other is fully or partially deflated, both of the first and second compartments 108, 110 may be becoming inflated at the same time, both of the first and second compartments 108, 110 may be becoming deflated at the same time, one of the first and second compartments 108, 110 may be becoming inflated while the other is becoming deflated, and so on. The control system 300 may be operable to selectively pressurize the first and second compartments 108, 110 as desired to any one or more predetermined pressures.

The control system 300 also is operable to selectively withdraw air from the interior region 208 of the envelope 200 independent of any inflation and/or deflation of the first and second compartments 108, 110 of the bladder 100. More specifically, the control system 300 is configured to selectively withdraw air from the interior region 208 of the envelope 200, thereby causing the first and second panels 202, 204 of the envelope to collapse against and conform to the bladder 100 to varying extents, as will be discussed further below. With the first and second panels 202, 204 of the envelope collapsed against the bladder 100, lateral (that is, end-to-end and side-to-side) motion of the bladder 100 with respect to the envelope 200, with respect to a user disposed thereon, and/or with respect to a support surface (for example, a hard surface or a foam or other flexible and resilient underlayment) upon which the bladder is disposed is inhibited or substantially eliminated.

For example, the control system 300 is operable in a first mode of operation to vent both of the first inflatable compartment 108 and the second inflatable compartment 110 to atmosphere. In the first mode of operation, the control system 300 may or may not draw a vacuum on the interior region 208 of the envelope 200, as will be discussed further below. In the first mode of operation, the first compartment isolation valve 314 is in its second position so that the first inflatable compartment 108 is vented to the atmosphere through the air outlet 328 and isolated from the pump 302. Similarly, the second compartment isolation valve 318 is in its second position so that the second inflatable compartment 110 is vented to the atmosphere through the air outlet 328 and isolated from the pump 302. The pump 302 may or may not be running. If the pump 302 is running, the pump 302 draws a vacuum on the interior region 208 of the envelope 200 via the pump suction line 304. The first and second inflatable compartments 108, 110 may be de-pressurized or evacuated more quickly with the pump 302 running than with the pump 302 not running. If the pressure in the pump suction line 304 drops below the calibrated vacuum relief valve set point pressure, the calibrated vacuum relief valve 310 opens, thereby coupling the suction of the pump 302 to the atmosphere through the calibrated vacuum relief valve 310 and the filter 324. Because the first compartment isolation valve 314 and the second compartment isolation valve 318 are in their second positions, thereby isolating the pump 302 from the first inflatable compartment 108 and the second inflatable compartment 110, respectively, the discharge of the pump 302 is routed to the atmosphere via the calibrated pressure relief valve 322 once the pressure in the pump output line 306 upstream of the first and second compartment isolation valves 314, 318 exceeds the calibrated pressure relief valve setpoint pressure.

The control system 300 is operable in a second mode of operation to inflate and pressurize the first inflatable compartment 108, vent the second inflatable compartment 110 to atmosphere, and draw a vacuum on the interior region 208 of the envelope 200. In the second mode of operation, the first compartment isolation valve 314 is in its first position so that the first inflatable compartment 108 is in fluid communication with the outlet of the pump 302 via the pump output line 306 and isolated from the atmosphere. The second compartment isolation valve 318 is in its second position so that the second inflatable compartment 110 is vented to the atmosphere through the air outlet 328 and isolated from the pump 302. In the second mode of operation, the pump 302 is running, thereby inflating and pressurizing the first inflatable compartment 108 with air discharged from the pump 302 via the pump discharge line 306 and the first compartment isolation valve 314. When the pressure in the pneumatic line connecting the first compartment isolation valve 314 to the first inflatable compartment 108 exceeds a predetermined pressure, as may be sensed by the first inflatable compartment pressure sensor 316, the controller 350 may cause the pump 302 to turn off. If the pressure in the pump output line 306 upstream of the first and second compartment isolation valves 314, 318 exceeds the calibrated pressure relief valve setpoint pressure, the calibrated pressure relief valve 322 opens, thereby venting the pump discharge line 306 upstream of the first and second compartment isolation valves 314, 318 to the atmosphere. Also, the pump 302 draws a vacuum on the interior region 208 of the envelope 200 via the pump suction line 304. If the pressure in the pump suction line 304 drops below the calibrated vacuum relief valve set point pressure, the calibrated vacuum relief valve 310 opens, thereby coupling the suction of the pump 302 to the atmosphere through the calibrated vacuum relief valve 310 and the filter 324.

The control system is operable in a third mode of operation to vent the first inflatable compartment 108 to atmosphere, inflate and pressurize the second inflatable compartment 110, and draw a vacuum on the interior region 208 of the envelope 200. In the third mode of operation, the first compartment isolation valve 314 is in its second position so that the first inflatable compartment 108 is vented to the atmosphere through the air outlet 328 and isolated from the pump 302. The second compartment isolation valve 318 is in its first position so that the second inflatable compartment 110 is in fluid communication with the outlet of the pump 302 via the pump output line 306 and isolated from the atmosphere. In the second mode of operation, the pump 302 is running, thereby inflating and pressurizing the second inflatable compartment 110 with air discharged from the pump 302 via the pump discharge line 306 and the second compartment isolation valve 318. When the pressure in the pneumatic line connecting the second compartment isolation valve 318 to the second inflatable compartment 110 exceeds a predetermined pressure, as may be sensed by the second inflatable compartment pressure sensor 320, the controller 350 may cause the pump 302 to turn off. If the pressure in the pump output line 306 upstream of the first and second compartment isolation valves 314, 318 exceeds the calibrated pressure relief valve setpoint pressure, the calibrated pressure relief valve 322 opens, thereby venting the pump discharge line 306 upstream of the first and second compartment isolation valves 314, 318 to the atmosphere. Also, the pump 302 draws a vacuum on the interior region 208 of the envelope 200 via the pump suction line 304. If the pressure in the pump suction line 304 drops below the calibrated vacuum relief valve set point pressure, the calibrated vacuum relief valve 310 opens, thereby coupling the suction of the pump 302 to the atmosphere through the calibrated vacuum relief valve 310 and the filter 324.

The control system 300 is operable in a fourth mode of operation to inflate and pressurize both the first inflatable compartment 108 and the second inflatable compartment 110, and to draw a vacuum on the interior region 208 of the envelope 200. In the fourth mode of operation, the first compartment isolation valve 314 is in its first position so that the first inflatable compartment 108 is in fluid communication with the outlet of the pump 302 via the pump output line 306 and isolated from the atmosphere. The second compartment isolation valve 318 is in its first position so that the second inflatable compartment 110 is in fluid communication with the outlet of the pump 302 via the pump output line 306 and isolated from the atmosphere. In the fourth mode of operation, the pump 302 is running, thereby inflating and pressurizing the first inflatable compartment 108 with air discharged from the pump 302 via the pump discharge line 306 and the first compartment isolation valve 314, and thereby inflating and pressurizing the second inflatable compartment 110 with air discharged from the pump 302 via the pump discharge line 306 and the second compartment isolation valve 318. When the pressure in the pneumatic line connecting the first compartment isolation valve 314 to the first inflatable compartment 108 exceeds a predetermined pressure and the pressure in the pneumatic line connecting the second compartment isolation valve 318 to the second inflatable compartment 110 exceeds a predetermined pressure, the controller 350 may cause the pump 302 to turn off. If the pressure in the pump output line 306 upstream of the first and second compartment isolation valves 314, 318 exceeds the calibrated pressure relief valve setpoint pressure, the calibrated pressure relief valve 322 opens, thereby venting the pump discharge line 306 upstream of the first and second compartment isolation valves 314, 318 to the atmosphere. Also, the pump 302 draws a vacuum on the interior region 208 of the envelope 200 via the pump suction line 304. If the pressure in the pump suction line 304 drops below the calibrated vacuum relief valve set point pressure, the calibrated vacuum relief valve 310 opens, thereby coupling the suction of the pump 302 to the atmosphere through the calibrated vacuum relief valve 310 and the filter 324.

The control system 300 may be operable to selectively inflate the first and second inflatable compartments 108, 110, to any desired pressures, for example, any pressures between one psi or less and fifteen psi or more, including but not limited to 1.0 psi, 1.5 psi, 2.0 psi, 2.5 psi, 3.0 psi, 3.5 psi, 4.0 psi, 4.5 ps, 5.0 psi, 5.5 psi, 6.0 psi, 6.5 psi, 7.0 psi, 7.5 psi, 8.0 psi, 8.5 psi, 9.0 psi, 9.5 psi, 10.0 psi, 10.5 psi, 11.0 psi, 11.5 psi, 12.0 psi, 12.5 psi, 13.0 psi, 13.5 psi, 14.0 psi, 14.5 psi, and 15.0 psi, and any intervening pressures. Any or all of the capacity of the pump 302, the setpoint pressures of the first and second pressure sensors 316, 320, the calibrated pressure relief valve setpoint, and operational parameters of the controller 350 may be varied to select the desired pressures.

The control system 300 may be operable to control the proportion of air withdrawn from the interior region 208 of the envelope 200 (compared to, for example, the maximum volume of the envelope 200), thereby controlling the degree of collapse of the panels 202, 204 of the envelope 200 against the bladder 100. Any or all of the capacity of the pump 302, the calibrated vacuum relief valve setpoint, and operational parameters of the controller 350 may be varied to select the desired proportion of air withdrawn from the interior region 208 of the envelope 200 and the degree of collapse of the panels 202, 204 of the envelope 200 against the bladder 100.

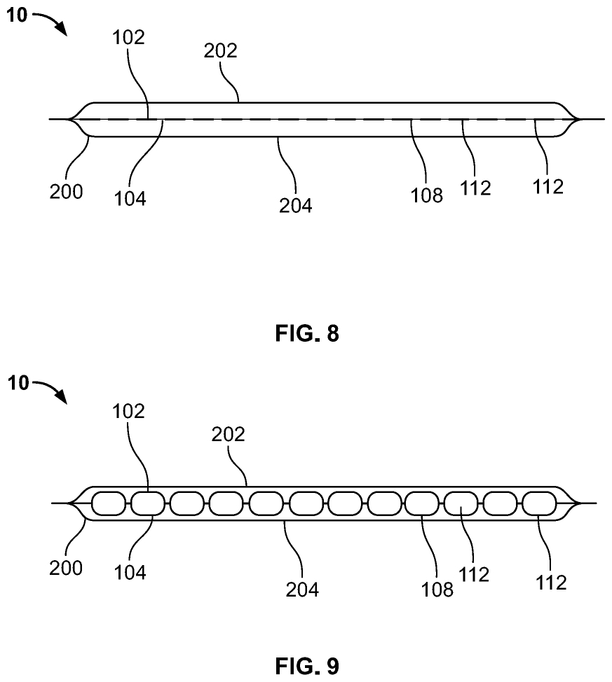

FIGS. 8-14 show the bladder 100 and envelope 200 in various states of inflation and vacuum, respectively.

FIG. 8 shows the bladder 100 with both of the first and second inflatable compartments 108, 110 fully deflated, and the interior region 208 of the envelope 200 at atmospheric pressure. The first and second panels 202, 204 are shown exaggeratedly spaced from the bladder 100 for clarity.

FIG. 9 shows the bladder 100 with the first inflatable compartment 108 fully inflated, and the interior region 208 of the envelope 200 at atmospheric pressure. The first and second panels 202, 204 are shown exaggeratedly spaced from the bladder 100 for clarity.

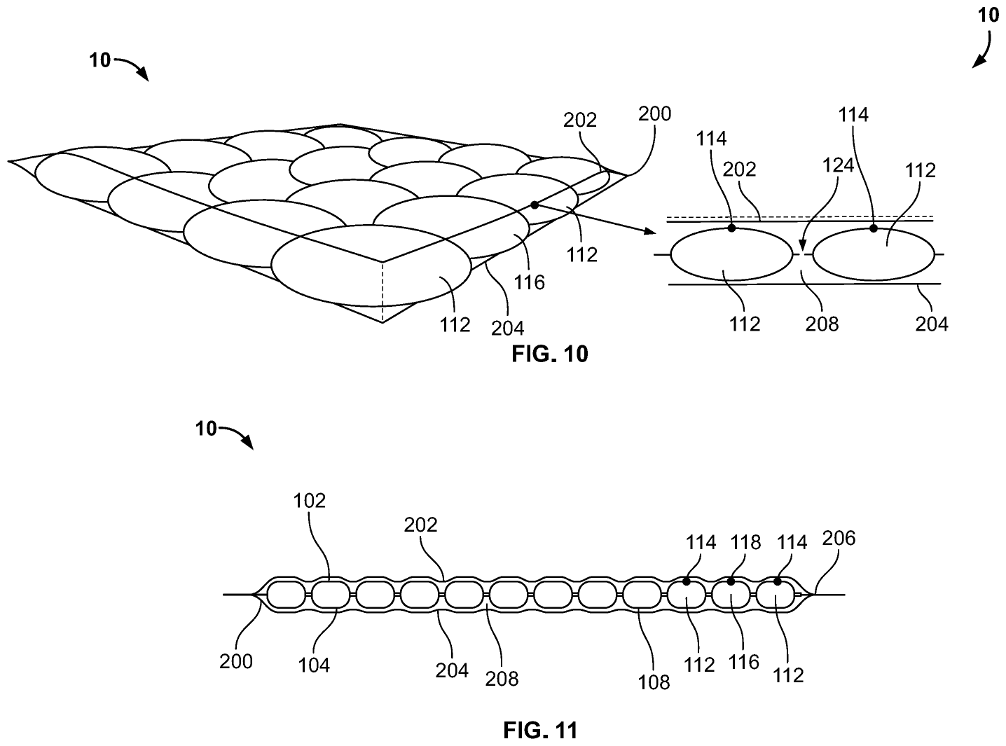

FIG. 10 shows the bladder 100 with both of the first and second inflatable compartments 108, 110 fully inflated, and the interior region 208 of the envelope 200 at atmospheric pressure. The first and second panels 202, 204 are shown exaggeratedly spaced from the bladder 100 for clarity.

FIG. 11 shows the bladder 100 with the first inflatable compartment 108 fully inflated, and a partial vacuum drawn on the interior region 208 of the envelope 200. The first panel 202 of the envelope 200 conforms to the first inflatable cells 112 of the first inflatable compartment 108 to a first degree. The second panel 202 of the envelope 200 conforms to the first inflatable cells 112 of the first inflatable compartment 108 to a second degree less than the first degree. The first panel 202 of the envelope 200 conforms to the first inflatable cells 112 of the first inflatable compartment 108 to a greater degree than does the second panel 202 of the envelope 200 because the first panel 202 has greater elasticity than the second panel 204, as discussed further above.

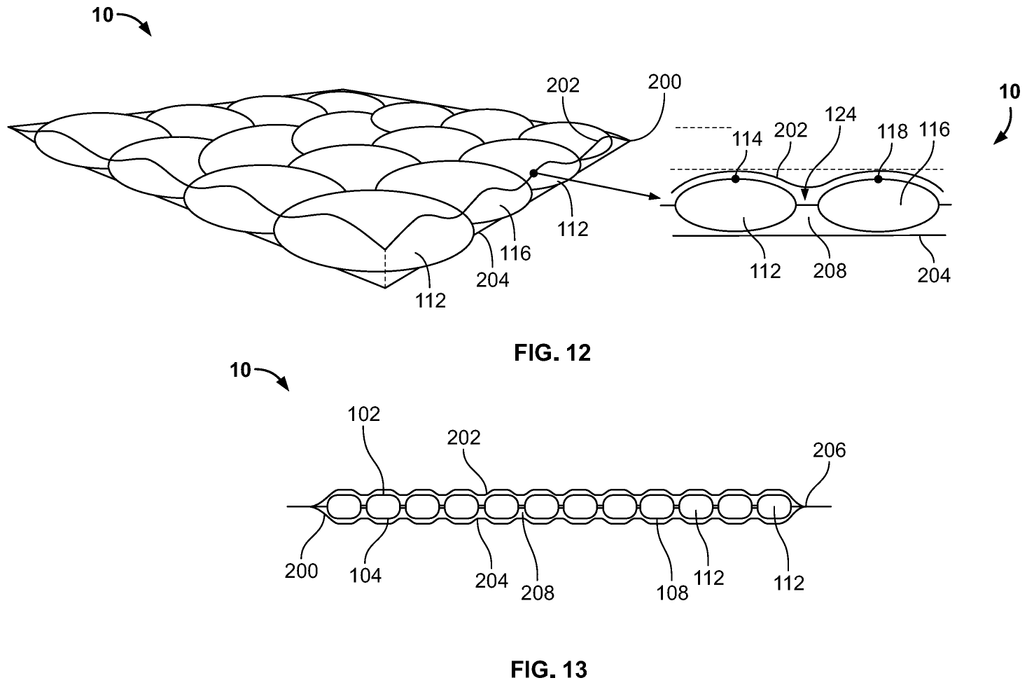

FIG. 12 shows the bladder 100 with both the first and second inflatable compartments 108, 110 fully inflated, and a partial vacuum drawn on the interior region 208 of the envelope 200. The first panel 202 of the envelope 200 conforms to the first inflatable cells 112 of the first inflatable compartment 108 and to the second inflatable cells 114 of the second inflatable compartment 110 to a first degree. The second panel 202 of the envelope 200 conforms to the first inflatable cells 112 of the first inflatable compartment 108 and to the second inflatable cells 114 of the second inflatable compartment 110 to a second degree less than the first degree. The first panel 202 of the envelope 200 conforms to the first and second inflatable cells 112, 114 of the first and second inflatable compartment 108, 110, respectively, to a greater degree than does the second panel 202 of the envelope 200 because the first panel 202 has greater elasticity than the lower panel 204, as discussed further above.

FIG. 13 shows the bladder 100 with the first inflatable compartment 108 fully inflated, and a greater vacuum drawn on the interior region 208 of the envelope 200 than represented in FIGS. 11 and 12. The first panel 202 of the envelope 200 conforms to the first inflatable cells 112 of the first inflatable compartment 108 to a first degree. The second panel 202 of the envelope 200 conforms to the first inflatable cells 112 of the first inflatable compartment 108 to a third degree. The third degree may be less than the first degree and greater than the second degree, or it may be substantially similar to the first degree. This phenomenon may occur because the relatively greater vacuum has greater effect on further collapsing the second panel 204 against the cells 112 of the bladder 100 (compared to the state represented in FIGS. 11 and 12) than it does on further collapsing the second panel 204 against the cells 112 of the bladder 100 (compared to the state represented in FIGS. 11 and 12). This phenomenon may be a consequence of relevant properties of the materials of which the first and second panels 202, 204 are made and or the relative thicknesses of the first and second panels 202, 204.

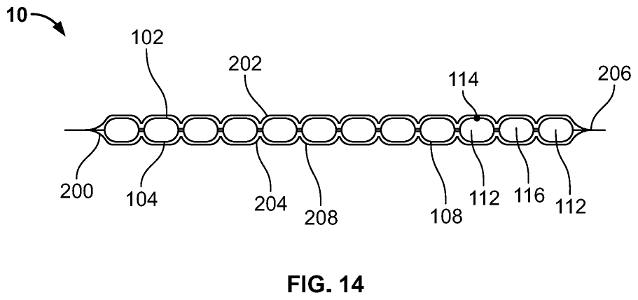

FIG. 14 is similar to FIG. 13 but shows both the first and second panels 202, 204 of the envelope more closely conforming to the first inflatable cells 112 of the bladder 100 because a still greater vacuum is drawn on the interior region 208 of the envelope 200.

In some embodiments, the first panel 202 of the envelope 200 may have elasticity similar to that of the second panel 204 of the envelope 200. In such embodiments, the first panel 202 of the envelope 200 could conform to the first inflatable cells 112 of the first inflatable compartment 108 to the same degree or a similar degree that the second panel 202 conforms to the first inflatable compartment 108 in the various states of operation as discussed above.

In modes of operation wherein one of the first and second inflatable compartments 108, 110 is inflated and the other of the first and second inflatable compartments 108, 110 is deflated, the upper and lower panels 202, 204 of the envelope 200 would conform to the bladder 100 in manners similar to those described above during the various modes of operation as described above.

The embodiments shown and described herein are illustrative and should not be construed to limit the scope of the invention as may be claimed herein or in any related application.

1. A support system comprising:
a bladder having a first inflatable compartment;
an envelope enclosing the bladder, the envelope comprising a first sheet and a second sheet bonded to the first sheet, thereby defining an interior region of the envelope; and
a pump coupled in selective fluid communication with the first inflatable compartment and in selective fluid communication with the interior region of the envelope, wherein the pump is operable to selectively inflate the first inflatable compartment and to selectively remove air from the interior region of the envelope and thereby cause the first sheet of the envelope to selectively conform to corresponding regions of the first inflatable compartment.

2. The support system of claim 1 wherein the portions of the first and second sheets of the envelope defining the interior region are imperforate.

3. The support system of claim 1 wherein the bladder comprises:
a first flexible sheet and a second flexible sheet, the first and second flexible sheets bonded together at a seam,
wherein the first and second flexible sheets and the seam cooperate to define the first inflatable compartment, the first inflatable compartment defining a plurality of inflatable cells, each of the plurality of inflatable cells defining a corresponding contact node.

4. The support system of claim 3 wherein the first sheet of the envelope selectively conforms to individual ones of the plurality of selectively inflatable cells.

5. The support system of claim 4 further comprising a valve arrangement operable to enable selective fluid communication of an inlet of the pump with the interior region of the envelope and to enable selective fluid communication of an outlet of the pump with the first inflatable compartment.

6. The system of claim 5 wherein the valve arrangement comprises a first valve operable to selectively and alternatingly enable fluid communication between the outlet of the pump and the first inflatable compartment or fluid communication between the first inflatable compartment and an atmosphere surrounding the support system.

7. The support system of claim 6 further comprising a controller operable to control alignment of the first valve and to selectively cause the pump to be energized.

8. The support system of claim 7 wherein the pump further is in selective fluid communication with the atmosphere surrounding the support system.

9. The support system of claim 8 wherein the bladder further comprises a second inflatable compartment, and wherein the valve system is further configured to enable selective fluid communication of the outlet of the pump with the second inflatable compartment.

10. The support system of claim 9 wherein the valve arrangement further includes a second valve operable to selectively and alternatingly enable fluid communication between the outlet of the pump and the second inflatable compartment or fluid communication between the second inflatable compartment and the atmosphere surrounding the support system.

11. A support system comprising:
a bladder, the bladder comprising:
a first flexible sheet and a second flexible sheet, the first and second flexible sheets bonded together at a seam,
wherein the first and second flexible sheets and the seam cooperate to define a selectively inflatable compartment, the selectively inflatable compartment defining a plurality of selectively inflatable cells, each of the plurality of selectively inflatable cells defining a corresponding contact node;
an envelope enclosing the bladder, the envelope comprising a first sheet and a second sheet bonded to the first sheet, thereby defining an interior region of the envelope;
a pump coupled in fluid communication with the interior region of said envelope, the pump configured to selectively remove air from the interior region of the envelope and thereby cause the first sheet of the envelope to selectively conform to corresponding regions of the support surface overlay;
a valve system operable to enable selective fluid communication of an inlet of the pump with the interior region of the envelope and to enable selective fluid communication of an outlet of the pump with the selectively inflatable compartment and with an atmosphere surround the support system; and
a controller operable to control valves of the valve system.

12. The support system of claim 11 wherein the valve system comprises a solenoid valve configured to selective enable: (i) fluid communication of an outlet of the pump with the selectively inflatable compartment or (ii) fluid communication of the selectively inflatable compartment with the atmosphere.

13. The support system of claim 12 further comprising a check valve enabling communication of fluid from the interior region of the envelope with an inlet of the pump and checking communication of fluid to the interior region of the envelope.

14. The support system of claim 12 wherein the bladder further comprises a second selectively inflatable compartment and wherein the valve system further comprises a second solenoid valve configured to selective enable: (i) fluid communication of the outlet of the pump with the second selectively inflatable compartment or (ii) fluid communication of the second selectively inflatable compartment with the atmosphere.

15. The support system of claim 14 wherein the inlet of the pump is in selective fluid communication with the atmosphere.

16. The support system of claim 14 further comprising a pressure sensor operable to sense pressure within the selectively inflatable compartment and a second pressure sensor operable to sense pressure within the second selectively inflatable compartment, wherein the pressure sensor and the second pressure sensor are operable to provide respective pressure signals to the controller.

17. The support system of claim 16 wherein the controller is operable to effect alignment of the solenoid valve to enable: (i) fluid communication of the outlet of the pump with the selectively inflatable compartment or (ii) fluid communication of the selectively inflatable compartment with the atmosphere.

18. The support system of claim 17 wherein the controller further is operable to effect alignment of the second solenoid valve to enable: (i) fluid communication of the outlet of the pump with the second selectively inflatable compartment or (ii) fluid communication of the second selectively inflatable compartment with the atmosphere.

19. The support system of claim 12 further comprising a relief valve operable to selectively enable fluid communication of the outlet of the pump with the atmosphere.

20. A support system comprising:
a bladder, the bladder comprising:
a first flexible sheet and a second flexible sheet, the first and second flexible sheets bonded together at a seam,
wherein the first and second flexible sheets and the seam cooperate to define a first inflatable compartment and a second inflatable compartment, each of the first inflatable compartment and the second inflatable compartment defining a corresponding plurality of selectively inflatable cells, each of the corresponding plurality of selectively inflatable cells defining a corresponding contact node;
an envelope enclosing the support surface overlay, the envelope comprising a first sheet and a second sheet bonded to the first sheet, thereby defining an interior region of the envelope;
a pump coupled in fluid communication with the interior region of said envelope, the pump configured to selectively remove air from the interior region of the envelope and thereby cause the first sheet of the envelope to selectively conform to corresponding regions of the support surface overlay;
a first valve operable to enable fluid communication of an outlet of the pump with the first inflatable compartment in a first mode of operation, and to enable fluid communication of the first inflatable compartment with the atmosphere in a second mode of operation;
a second valve operable to enable fluid communication of the outlet of the pump with the second inflatable compartment in the second mode of operation, and to enable fluid communication of the second inflatable compartment with the atmosphere in the first mode of operation; and
a controller operable to control the pump, the first valve, and the second valve.
